(19) United States
(12) Patent Application Publication
(10) Pub. No.: US 2017/0341244 A1
(43) Pub. Date: Nov. 30, 2017

(54) KNIFE WITH LASER ENGRAVED FISHSCALE LINES

(71) Applicant: EVERGOOD HARDWARE PRODUCTS CO.,LTD., Nantou County (TW)

(72) Inventor: CHEN-FEN CHEN, Nantou County (TW)

(73) Assignee: EVERGOOD HARDWARE PRODUCTS CO.,LTD., Nantou County (TW)

(21) Appl. No.: 15/168,149

(22) Filed: May 30, 2016

(51) Int. Cl. B26B 9/00; B26B 3/02

(52) U.S. Cl. CPC B26B 9/00; B26B 3/02

(57) ABSTRACT

A knife with laser engraved fishscale lines includes a knife body and a knife handle, and the knife body is a sheet member and has a cutting edge, a spine and two blade surfaces, and the blade surfaces are polished mirror surfaces, and the blade surface has the laser engraved fishscale lines which are indented lines indented into the blade surface, and the knife handle is combined with an end of the knife body, so that the knife has the effects of showing obvious laser engraved lines, lowering manufacturing cost, and preventing food sticking.

### BACKGROUND OF THE INVENTION

### Field of the Invention

The present invention relates to the field of a knife, in particular to the knife with fishscale lines formed on a blade surface of the knife by laser engraving.

### Description of Related Art

Various types of knives such as chef knives, fish knives, paring knives, fruit knives and folding knives used for cutting, slicing or peeling generally comprise a knife body in a sheet form and a knife handle combined with an end of the knife body, and the knife body has a sharp cutting edge, a blunt spine, a blade tip (or the tip of the knife), and two blade surfaces, wherein the two blade surfaces are generally abrasive surfaces with hair lines formed on the blade surface by a surface grinding process.

However, processes including a surface etching process, a die stamping process, a cutting process and/or a grinding process are generally required to form special lines on the blade surface of the knife, and the manufacturing process particularly the surface etching usually uses chemicals, and the emission of chemicals causes environmental pollutions, so that there is an environmental protection issue. For the manufacturing method of a more complicated line such as the lines of a Japanese knife, a steel sheet is folded, heated and forged repeatedly, and then ground to form the lines on the blade surface. Obviously, such manufacturing process of the lines is too complicated. In addition, the art of manufacturing special lines for Damascus knives has been lost for hundreds of years, and the present manufacturing technology no longer can fully express the special lines of the Damascus knife.

Therefore, the conventional manufacturing method of forming lines on a blade surface of a knife is very time-consuming and cumbersome and not conducive to cost control, and it also has the issue of environmental pollution. In addition, when a conventional knife is used for cutting, sliding or peeling fruits or cutting fishes and raw meats, food often stick on the blade surface, and thus leading to an unsmooth kitchen work flow. Obviously, the conventional knives require improvements.

### SUMMARY OF THE INVENTION

In view of the aforementioned drawbacks of the prior art, the inventor of the present invention based on years of experience in the related industry to conduct extensive researches and experiments, and finally developed a knife with laser engraved fishscale lines in hope of achieving the purposes of showing obvious laser engraving lines, lowing manufacturing cost and preventing food sticking.

It is a primary objective of the present invention to provide a knife with laser engraved fishscale lines capable of showing obvious laser engraved lines, lowering manufacturing cost, and preventing food sticking.

To achieve the aforementioned and other objectives, the present invention provides a knife with laser engraved fishscale lines comprising a knife body and a knife handle, wherein the knife body is a sheet member and has a cutting edge, a spine and two blade surfaces, and the blade surface is a polished mirror surface, and the blade surface has a plurality of laser engraved fishscale lines, and the knife handle is combined with an end of the knife body.

In the knife with laser engraved fishscale lines, the fishscale lines are continuous staggered arc lines.

In the knife with laser engraved fishscale lines, the fishscale lines are indented lines indented into the blade surface.

In the knife with laser engraved fishscale lines, the indented lines have a depth from 0.1 mm to 0.5 mm.

In the knife with laser engraved fishscale lines, the knife handle is integrally formed or coupled with an end of the knife body.

In the knife with laser engraved fishscale lines, the knife body is a sheet member made of stainless steel or plastic steel.

In the manufacture of the knife with laser engraved fishscale lines in accordance with the present invention, the two blade surface of the knife body are polished to form mirror surfaces, and then fishscale lines are formed on the blade surface by a laser engraving process, so that the two blade surfaces of the knife body have special lines and capable of achieving the following effects:

(1) The laser engraving process is fast, efficient and simple, so that the manufacturing cost for forming the fishscale lines on the two blade surfaces of the knife body can be lowered.

(2) The blade surfaces are polished to form mirror surfaces in advance, and then the blade surface is etched by the laser engraving process, so that the fishscale lines formed by the laser engraving process are obvious.

(3) Since the fishscale lines are manufactured by the laser engraving process, therefore the lattices at the positions of the lines shown on the blade surface are different from those at other positions of the mirror surface, particularly the laser engraved fishscale lines are indented lines. When food is cut, the fishscale lines can prevent food from sticking onto the blade surface.

### BRIEF DESCRIPTION OF THE DRAWINGS

FIG. 1 is a schematic view of a knife with laser engraved fishscale lines of the present invention;

FIG. 2 is a schematic view showing the principle of engraving fishscale lines by laser in accordance with the present invention; and

FIG. 3 is a partial blowup sectional view of fishscale lines of the present invention.

### DETAILED DESCRIPTION OF THE INVENTION

The aforementioned and other objects, characteristics and advantages of the present invention will become apparent with the detailed description of the preferred embodiments and the illustration of related drawings as follows.

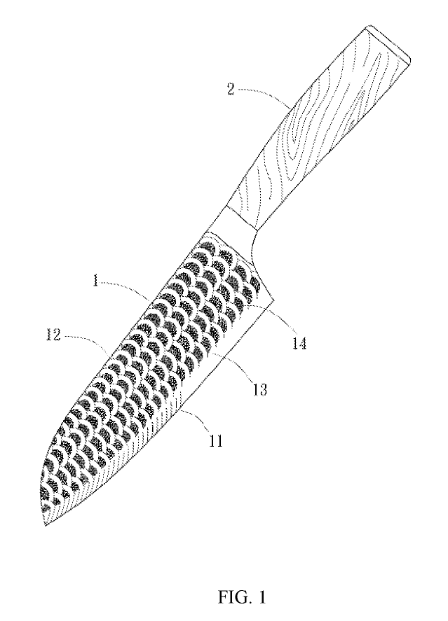

With reference to FIG. 1 for a schematic view of a knife with laser engraved fishscale lines in accordance with a preferred embodiment of the present invention, the knife comprises a knife body 1 and a knife handle 2, wherein the knife body 1 is a sheet member made of metal or plastic steel such as #304 stainless steel and other material, so that the knife body 1 has a sharp cutting edge 11, a blunt spine 12, and two blade surfaces 13 formed on both sides of the knife body 1, and the knife may be in form of a chef knife, and the knife may be in form of a fish knife, a paring knife, a fruit knife or in other form of knife. The knife handle 2 is integrally formed or coupled with an end of the knife body 1, wherein the knife handle 2 may be a wooden handle, a plastic steel handle, or a plastic handle coupled to an end of the knife body 1, and the knife handle 2 may be made of the same material of the knife body 1 and integrally formed with the knife body 1. It is noteworthy that the blade surface 13 of the knife body 1 of the present invention has fishscale lines 14 which are laser engraved lines the fishscale lines 14, and more specifically the fishscale lines 14 are continuous staggered arc lines, and the size of the arc lines is not limited specifically, so that both surfaces of the knife body 1 have special lines similar to the surfaces of a silver dragon fish or a red dragon fish.

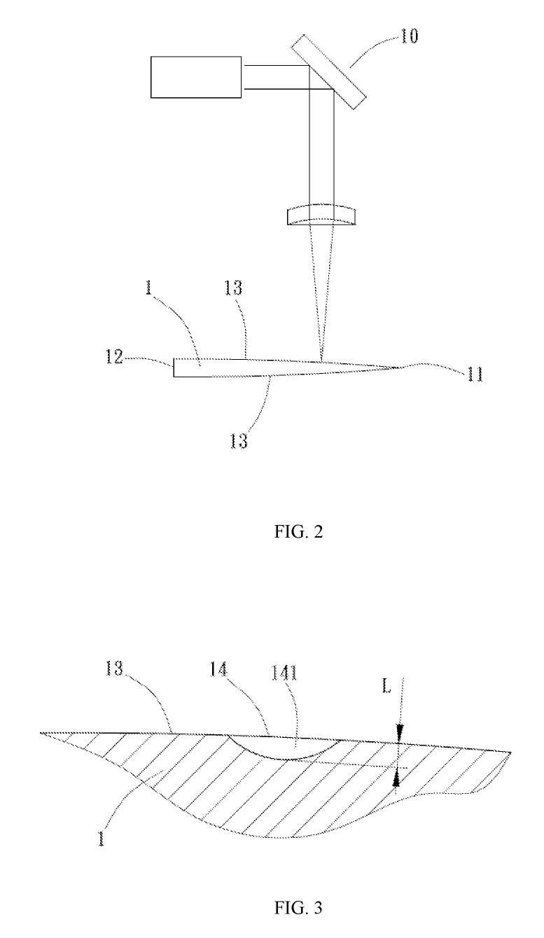

With reference to FIGS. 1 and 2 for the manufacturing method and structure of the fishscale lines 14, the blade surfaces 13 of the knife body 1 are polished to form mirror surfaces, and then the knife body 1 is placed on a laser engraver 10 and processed by high-energy laser beams to heat the blade surface 13 along a predetermined path, so as to form and the fishscale lines 14 on the blade surfaces 13 of the knife body 1. The fishscale lines 14 formed on the blade surfaces 13 by the laser manufacturing process makes the lattices at the positions of the fishscale lines 14 different from the lattices at other positions of the mirror surfaces, and the laser manufacturing process may be used to form the fishscale lines 14 into indented lines 141 indented into the blade surfaces 13, and the indented lines 141 preferably have a depth L as shown in FIG. 3, and the depth L falls within a range from 0.1 mm to 0.5 mm, so that the fishscale lines 14 have a three-dimensional appearance.

With the technology of the present invention, the fishscale lines 14 can be formed on the two blade surfaces 13 of the knife body 1 of the knife by a fast, efficient, simple laser engraving process. Compared with the conventional surface etching, die stamping, cutting, grinding or forging processes, the present invention is capable of manufacturing the same blade surfaces with the fishscale lines to achieve the effect of lowering the manufacturing cost. In the present invention, the blade surfaces 13 of the knife body 1 are polished to form mirror surfaces first, and then the fishscale lines 14 are formed on the blade surfaces 13 by the laser engraving process, so that the fishscale lines 14 formed by the laser engraving process are obvious. It is noteworthy that the fishscale lines 14 of the present invention are manufactured by the laser engraving process, so that the lattices at the positions of the lines on the blade surfaces 13 are different from the lattices at other positions of the mirror surfaces. In addition, the fishscale lines 14 may be manufactured into indented lines by the formed by the laser engraving process, so that the structure of the indented lines is capable of separating food from the blade surface 13 or preventing food from sticking the blade surface while cutting the food.

While the invention has been described by means of specific embodiments, numerous modifications and variations could be made thereto by persons skilled in the art without departing from the scope and spirit of the invention set forth in the claims.

What is claimed is:

1. A knife with laser engraved fishscale lines, comprising a knife body and a knife handle, wherein the knife body is a sheet member and has a cutting edge, a spine and two blade surfaces, and the blade surface is a polished mirror surface, and the blade surface has a plurality of laser engraved fishscale lines, and the knife handle is combined with an end of the knife body.

2. The knife with laser engraved fishscale lines according to claim 1, wherein the fishscale lines are continuous staggered arc lines.

3. The knife with laser engraved fishscale lines according to claim 1, wherein the fishscale lines are indented lines indented into the blade surface.

4. The knife with laser engraved fishscale lines according to claim 2, wherein the indented lines have a depth from 0.1 mm to 0.5 mm.

5. The knife with laser engraved fishscale lines according to claim 1, wherein the knife handle is integrally formed or coupled with an end of the knife body.

6. The knife with laser engraved fishscale lines according to claim 1, wherein the knife body is a sheet member made of stainless steel or plastic steel.
